(19) United States
(12) Patent Application Publication
(10) Pub. No.: US 2012/0222667 A1
(43) Pub. Date: Sep. 6, 2012

(54) FIREPLACE INCLUDING A SAFETY PROXIMITY WARNING SYSTEM

(75) Inventors: Antonio VENDRAMINI, Padova (IT); Giovanni BALLADORE, Conselve (PD) (IT)

(73) Assignee: SIT LA PRECISA S.P.A. CON SOCIO UNICO, Padova (IT)

(21) Appl. No.: 13/039,032

(22) Filed: Mar. 2, 2011

(51) Int. Cl. F24B 1/187; G08B 17/00

(52) U.S. Cl. 126/502; 340/541

(57) ABSTRACT

A fireplace is provided, in which a flame can be lit. The fireplace including a warning system, which includes a proximity sensor to detect the presence of object within an active volume, the volume surrounds at least a portion of the fireplace. The system also includes an alarm device to emit an alarm signal, a clock to calculate a time elapsed since the switching off of the fireplace, and a processing unit receiving as input data from the clock and the proximity sensor, and outputting command signals to the alarm device. The alarm device is activated by the processing unit to generate an alarm signal when an object is detected by the proximity sensor as entering the active volume and the fireplace has been switched off since no later than a first pre-defined time interval. Also provided is a method for warning when an object enters the active volume of a fireplace.

### FIELD OF INVENTION

The present invention related to a fireplace including a safety system to warn the user in case an object is approaching the fireplace while an element of the latter is still hot.

### BACKGROUND

Fireplaces, using wood, gas or electricity, are widespread both in domestic and in working buildings. They are appreciated for their capability of creating a pleasant “atmosphere”, i.e. fireplaces are commonly used not only for their ability to heat a certain environment, but also for their aesthetic appeal. For this reason, they are normally installed in environments where people and/or pets are generally present, e.g. in the living room of a house or in the meeting room of an office.

However, fireplaces are also posing some hazardous threats to the health: parts of the fireplace becomes extremely hot during the normal functioning of the fireplace. Indeed, a fireplace includes a combustion chamber, wherein wood is burned, or gas is ignited and a flame is present in case of a gas fireplace. The flame and elements in the proximity of the combustion chamber can therefore reach elevated temperatures, which can cause burns to individuals or damage to objects that enter into contact with them.

Safety or warning systems have been developed in this field in order to avoid such burns or damages.

US 2003/201896 in the name of Determan et al. discloses a temperature warning system for a fireplace which includes, for example, an arrangement to sense a temperature of at least one area of the fireplace and a signaling device controlled by the arrangement to provide a signal responsive to the temperature of the area. The arrangement may include an electrical circuit including a thermistor positioned outside the viewing area to measure the temperature of an area of the fireplace. The signaling device may include visual or audible signaling devices for signaling to a user when an area of the fireplace is above a threshold temperature.

US 2004/081930 in the name of HON Technology Inc. shows a proximity warning system for a fireplace including a monitor module and an alarm module. The monitor module is configured to sense when an object, such as a person, enters a defined zone proximate to the fireplace. The monitor module may use a variety of techniques to sense when an object enters the defined zone. For example, the monitor module may use capacitance or pulse infrared light to detect when an object enters the defined zone. The alarm module is coupled to the monitor module to generate an alarm when the monitor module senses that the object has entered the defined zone. The alarm may be audible or visual.

IE 980291 in the name of Tekelek Europe Ltd discloses an electronic fire guard for use in the vicinity of a fireplace comprising a sensor and alarm means, the sensor having transmitting and receiving means, for generating and monitoring an electromagnetic field around said sensor, wherein the sensor causes the alarm means to be activated when a disturbance in the electromagnetic field is detected.

However most of the warning systems above described are checking the temperature of the elements of the fireplace that might become hot and they emit a warning signal only above a certain detected temperature. In addition, these prior art systems are functioning only when the fireplace is switched on, i.e. only when a flame is present in the fireplace.

### SUMMARY

The present invention relates to a fireplace, which can be either a fireplace using wood or a gas fireplace, including a warning system comprising a proximity sensor which detects the approach of objects to the fireplace itself and consequently emits a warning signal, and which assures such a control also when the fireplace is switched off.

In detail, the warning system of the invention can be activated (e.g. it can emit a warning signal) not only when the fireplace is working, i.e. when the fireplace is heating for example because a flame is present, but also—under certain conditions—when the fireplace is switched off. In addition, the activation of the warning system is not dependent on the temperature of the elements of the fireplace.

More in detail, the fireplace of the invention includes a proximity sensor, which detects the entrance of objects in a given volume around the fireplace. The volume covered by the sensor depends on the type of proximity sensor used. In the following, the volume covered by the sensor, i.e. the volume around the fireplace which is within the operative range of the proximity sensor, will be called active volume.

The proximity sensor of the invention can be of any type, i.e. a capacitive sensor, a magnetic sensor, etc. Preferably, it includes a transmitter which emits electromagnetic waves and a receiver in order to detect the return signal. To detect whether an object has entered the active volume, the proximity sensor senses changes in the return signal. The range within which the sensor can detect the approach of an object defines the size of the active volume. Preferably, the proximity sensor of the invention emits infrared signals or ultrasounds signals. Alternatively, it includes a mixed technologies like it can generate an emission of both infrared and electromagnetic waves.

With the term “object” which can be detected by the proximity sensor any type of living beings, such as a pet, a kid or a adult, or non living beings, such as a ball, a toy, or any other inanimate object is meant.

In addition to the proximity sensor, the fireplace of the invention includes an alarm device to emit an alarm signal in case, under the condition below outlined, an object as above defined has entered the active volume around the fireplace and thus detected by the proximity sensor.

The alarm device can be either a visual or an audible device, for example a LED which is illuminated in red and/or blinking. Preferably the alarm signal is an acousting warning emitted by a loudspeaker. The audible warning might also include a recorded voice.

According to the invention, the warning system of the invention can emit warning signals in case an object enters in the active volume, not only when the fireplace is ignited, but—and in particular—when the fireplace is switched off, i.e. no flame is present in the fireplace. In detail, the warning system is active at least for a time interval equal to a first pre-defined time interval T₁ after the fireplace has been switched off.

According to the above, therefore, the fireplace including the warning system of the invention emits a warning in case an object enters the active volume both when the fireplace is functioning and when the fireplace has been switched off since no longer than T₁ minutes.

More preferably, the warning system is activated and can emit the above mentioned alarm signal not immediately at the ignition of the fireplace, but after a second pre-defined time interval time T₂ since the lighting of the flame in the fireplace. In other words, the working range of the warning system is preferably comprised between T₂ minutes after lighting and T₁ minutes after switching off of the fireplace. Preferably T₁=T₂.

Indeed, Applicants have realized that the most dangerous time during which the majority of injuries or damages takes place is just after the switching off of the fireplace: in this time frame there is no visual or audible “warning” of the fact that elements of the fireplace, in particular the front glass through which the flame is visible when lighted, can be still at a very high temperature. Indeed, when the flame is not present, it is substantially impossible to understand that touching the fireplace can cause a burn without knowing that the fireplace has just been switched off.

The fireplace of the invention therefore solves this problem keeping the warning system active for a period T₁ after the switching off. This first pre-defined time interval is set to be long enough to let the fireplace cool down till a reasonable temperature, i.e. a temperature that it is not hazardous for any object (or at least most of them). It is preferred to wait a second pre-defined time T₂ before activating the warning system to save energy, i.e. during the first interval T₂ of operation, the fireplace has not reached yet a dangerous temperature.

In addition, the system is independent from any temperature sensor, thus independent from any breaking or malfunctioning of the same. In addition, the system of the invention is rather simple and relatively cheap.

### BRIEF DESCRIPTION OF THE DRAWINGS

The invention will be better understood in consideration of the following detailed description of various embodiments in connection with the appended drawings, in which

FIG. 1 is a simplified perspective view of a fireplace according to the present invention;

FIG. 2 includes a schematic top view of the fireplace of FIG. 1;

FIGS. 3a-3f are illustrations of various steps representative of the functioning of the fireplace of the invention;

FIG. 4 is a schematic diagram of a electronic unit included in the fireplace of the invention.

### DETAILED DESCRIPTION OF THE PREFERRED EMBODIMENTS

The present invention is relative to a fireplace in which a flame can be lightened for aesthetic and/or heating purposes. The flame can be obtained—among others—due to wood's burning or gas ignition. The fireplace can be programmable, in particular via a remote control.

With reference to FIG. 1, a fireplace 1 is depicted, including a combustion chamber 4 which might be closed by a front panel, for example a panel including a front glass 2 through which a flame 3 which is present in the combustion chamber 4 when the fireplace is switched on is visible from the outside of the fireplace. Other components of a typical fireplace such as blowers, fans, air intakes, gas valve, burners, etc are removed for clarity from FIG. 1 and are considered to be known in the art, therefore not further described in details.

It is also to be understood that the fireplace of the invention can have any known shape and might include more than one combustion chamber and/or more than one front panel. The fireplace can be for example an electric fireplace, a gas fireplace, a solid-fuel fireplace or any fireplace that mimics a fireplace burning coal, wood, or natural gas. In addition, the fireplace can be fueled with wood or coal. It can be a vented or a ventless fireplace.

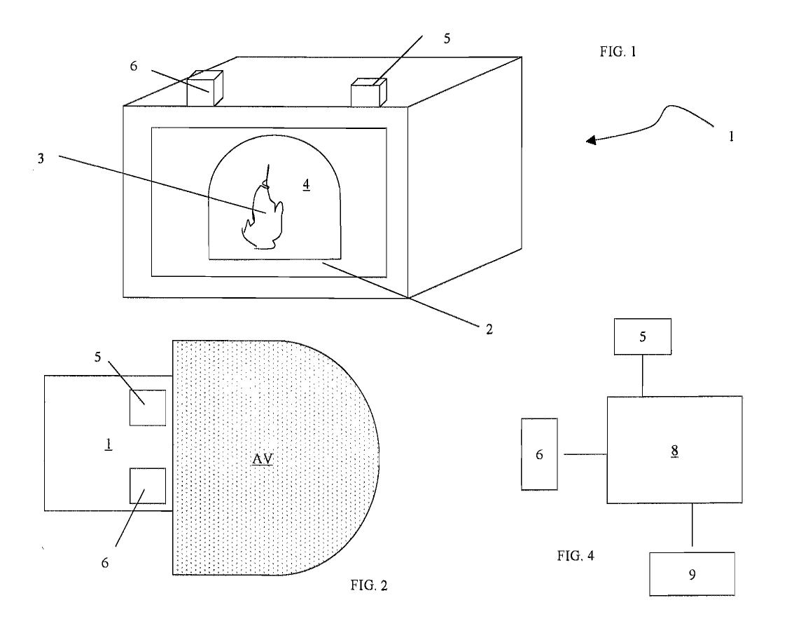

According to the invention, the fireplace includes a warning system in order to warn the user and/or the environment that an object has entered the active volume around the fireplace and the fireplace is functioning within a certain time interval better indentified below. The active volume AV is schematically depicted with reference to FIG. 2 and it is a volume which surrounds at least a portion of the fireplace.

The warning system in detail includes a proximity sensor 5, in particular an infrared or ultrasonic sensor, to detect objects present within the active volume. The active volume AV is defined as the volume within which the sensor 5 can detect the presence of an object: therefore the portion of the fireplace which is surrounded by the active volume depends on the location of the same and on the type of sensor. Preferably, the proximity sensor 5 is mounted on the fireplace itself. Generally, the active volume AV is substantially a sphere of given radius around the proximity sensor 5. The proximity sensor 5 includes a transmitter and a receiver (not shown) in order emit electromagnetic radiation and to sense changes in the return radiation: a change in the latter means movements of an object within the active volume AV. The functioning of a proximity sensor such as the one used in the invention is considered to be known in the art.

In addition, the warning system includes an alarm device 6 to emit an alarm signal, which can be either a visual or an audible signal. For example, the alarm device 6 can include one or more lights that can be activated under certain circumstances better detailed below. The intensity of the alarm signal can change, for example in case of a light the closer an object gets to the fireplace, the more intense the light is. Alternatively or in addition, the light can blink and the frequency of the blinking can vary again depending on the distance between the object and the fireplace. The alarm signal can be also a sound of variable intensity emitted by a loudspeaker, including also a recorded message. Moreover, the alarm signal can be any combination of audible and visual signals. Preferably, the alarm device 6 is mounted on the fireplace 1, however any other location in the proximity of the fireplace 1 is possible as well, such as in a remote place located in a different room(s) than the one in which the fireplace is present.

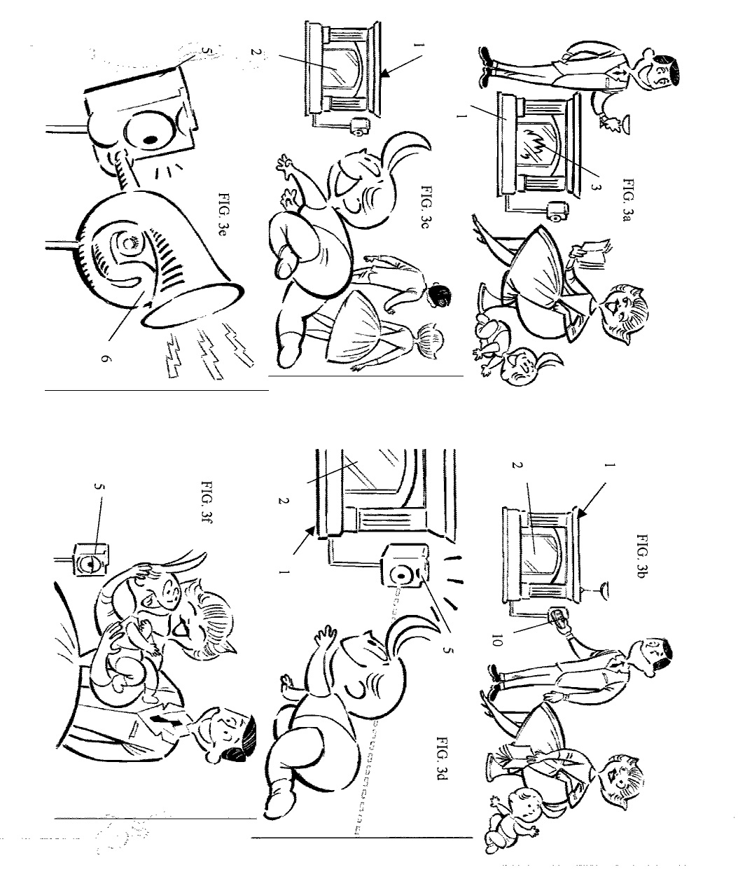

With now reference to FIG. 4, the warning system of the invention in addition includes a processing unit 8 receiving as inputs data from the proximity sensor 5 and it outputs signals in order to operate the alarm device 6. The warning system also includes a clock 9 which might be incorporated in the processing unit 8 or might emit an additional input to the processing unit 8.

The clock 9 is apt to calculate the time elapsed since the lighting of the flame 3 in the fireplace and the time elapsed since the switching off of the flame 3. However, the clock 9 in an additional embodiment might calculate only the latter time.

The coupling between the processing unit 8, clock 9, sensor 5 and alarm device 6 can be either via connecting wire or wireless.

When the fireplace 1 is switched on, i.e. the flame 3 is lightened, the clock 9 starts to measure a time interval since the switching on. The flame can be lightened by any known means, for example via a knob or a push button that for example control a spark (not shown) and opens the gas valve. The warning system of the invention can be either activated simultaneously to the switching on of the fireplace 1 or, preferably, after a time T₂ from the switching on. In the latter case, processing unit 8 controls the switching on of the warning system of the invention: clock 9 sends a signal to the processing unit 8 when a time T₂ has elapsed and in turn the processing unit emits a command signal to switch on the whole warning system (i.e. sensor 5 and device 6).

When the warning system is on, any object entering the active volume AV around the fireplace 1 is detected by the proximity sensor 5 which sends a signal to the processing unit 8 of “alert”, i.e. a signal indicating that an object is entering in the active volume AV. The processing unit 8 in turn sends a control signal to the alarm device 6 to command the latter to generate an alarm signal which is then emitted according to the selected type of device.

When the flame 3 is switched off, either voluntarily or due to the fact that the desired temperature in the environment where the fireplace is situated has been reached, the clock 9 starts measuring the elapsed time since the flame has disappeared. After a pre-determined first time T₁, during which the warning system is still active, i.e. during which if an objects enters the active volume an alarm signal is generated by the alarm device 6, the warning system is switched off automatically, for example by the processing unit 8. As above, the clock sends a signal to the processing unit 8 that a time T₂ has elapsed and in turn the processing unit emits a command signal to switch off the whole warning system.

The duration of time intervals T₁ and T₂ can be changed by the user depending on the changing environment conditions (e.g. in case the temperature desired in the room is changed: the higher the temperature, the longer T₁) or during installation of the fireplace 1. In addition, the time measured by the clock 9, i.e. the time elapsed after switching on or switching off of the fireplace, can also be displayed in a monitor (not shown) on the fireplace 1 or remote from the same. Moreover, the type of alarm signal emitted by the alarm device 6 can also change depending on the elapsed time: the closer the elapsed time is to T₁, the “weaker” the alarm signal is (for example very close to T₁ the red light can change into yellow). Sub-interval of T₁ can be defined in which different alarm signals are emitted by the alarm device.

As depicted in FIGS. 3a-3f, the fireplace 1 of the invention is functioning and heating a given room where persons can be present, such as a family with small kids (see FIG. 3a). Kids are normally prevented by parents to approach the fireplace in which flame 3 is present. The fireplace 1 is then switched off using a standard remote control 10 as depicted in FIG. 3b. Being the flame 3 not present any more, the fireplace can be improperly considered “safe” by adults and kids can be left unattended in the proximity of the same (see FIG. 3c). However, due to the fact that the warning system of the invention is still operative at least for a time T₁ after the fireplace has been switched off, the proximity sensor 5 detects the approaching of the kid (FIG. 3d) and the processing unit 8 activates the alarm device 6 which emits in this case an acoustic warning signal (see FIG. 3e) avoiding therefore any harm to the kid (depicted in FIG. 3f).

What is claimed is:

1. A fireplace in which a flame can be lit, said fireplace including a warning system, said system comprising:
a proximity sensor to detect the presence of object within a active volume, said volume surrounding at least a portion of said fireplace,
an alarm device to emit an alarm signal,
a clock to calculate a time elapsed since the switching off of said fireplace,
a processing unit receiving as input data from said clock and said proximity sensor, and outputting command signals to said alarm device,
said alarm device being activated by said processing unit to generate an alarm signal when an object is detected by said proximity sensor as entering said active volume and the fireplace has been switched off since no later than a first pre-defined time interval.

2. The fireplace of claim 1, wherein said clock calculates a time elapsed since the switching on of said fireplace and the alarm device is activated by said processing unit to generate an alarm signal when an object is detected by said proximity sensor as entering said active volume and the fireplace has been switched on since no earlier than a second pre-defined time interval.

3. The fireplace of claim 2, wherein said first and said second time interval are substantially identical.

4. The fireplace of claim 1, wherein said proximity sensor is an ultrasonic or an infrared sensor.

5. The fireplace of claim 1, wherein said fireplace is a gas fireplace.

6. The fireplace of claim 1, wherein said alarm signal is an acoustic and/or a visual signal.

7. The fireplace of claim 6, wherein said alarm device includes a loudspeaker and/or a LED.

8. A method for warning when an object approaches a fireplace, the method comprising the steps of:
providing a proximity sensor to detect when an object enters an active volume at least partially surrounding said fireplace,
providing an alarm device for generating an alarm signal,
switching off said fireplace,
calculating a time elapsed since the switching off of said fireplace,
generating said alarm signal when an object enters the active volume and the time elapsed since switching off is not longer than a first pre-defined time-interval.

9. A method for warning when an object approaches a fireplace, the method comprising the steps of:
providing a proximity sensor to detect when a object enters an active volume at least partially surrounding said fireplace,
providing an alarm device for generating an alarm signal,
calculating a time elapsed since switching on of said fireplace,
generating said alarm signal when an object enters the active volume and the time elapsed since switching on is longer than a second pre-defined time-interval.

10. A method for warning when an object approaches a fireplace, the method comprising the steps of:
providing a proximity sensor to detect when a object enters an active volume at least partially surrounding said fireplace,
providing an alarm device for generating an alarm signal,
switching on said fireplace,
calculating a time elapsed since the switching on of said fireplace,
calculating a time elapsed since switching off of said fireplace if the fireplace has been switched off,
generating said alarm signal when an object enters the active volume and either the time elapsed since switching off is not longer than a first pre-defined time-interval or the time elapsed since switching on is longer than a second pre-defined time-interval.
